(19) United States
(12) Patent Application Publication
(10) Pub. No.: US 2011/0113774 A1
(43) Pub. Date: May 19, 2011

(54) IMPROVEMENTS IN EMISSIONS CONTROL

(75) Inventors: Andrew Dominic Nunn, Reading (GB); Martyn Vincent Twigg, Cambridge (GB)

(73) Assignee: JOHNSON MATTHEY PUBLIC LIMITED COMPANY, London (GB)

(21) Appl. No.: 12/919,822

(22) PCT Filed: Feb. 27, 2009
(86) PCT No.: PCT/GB09/00563

§ 371 Date: Jan. 27, 2011

(30) Foreign Application Priority Data
Feb. 28, 2008 (GB) 0803670.9

(51) Int. Cl. F01N 3/18; F01N 3/10; F02C 6/12

(52) U.S. Cl. 60/605.1; 60/301; 60/274

(57) ABSTRACT

A lean-burn natural gas-fuelled diesel engine comprising an exhaust system comprising an oxidation catalyst. The engine can be used in a mobile application, e.g. to power a vehicle, or it can be a stationary engine for power generation.

The present invention concerns improvements in emission control. More especially, the invention concerns particularly natural gas-fuelled internal combustion engines provided with catalytic emission control systems, typically for vehicular use but which can also be used for treating emissions from stationary engines for power production.

Throughout this specification and claims, the term “diesel engine” will be used to refer to compression ignition internal combustion engines.

There is a trend towards using compressed natural gas in heavy-duty diesel engines, at least partially because of the perception that such engines are “cleaner” in exhaust gas emission terms than liquid diesel-fuelled engines. The present invention may be applied both to newly-built engines and to diesel engines modified to run on natural gas rather than on liquid diesel fuel. Conveniently the natural gas can be stored as compressed natural gas (CNG), or if appropriate as liquefied natural gas (LNG).

The term “natural gas” includes gases containing more than 30% by volume of methane obtained from mineral sources such as natural gas wells, and gases associated with other higher hydrocarbons, from the gasification of biomasses, from coal gasification processes, from landfill sites, or produced by hydrogenation of carbon oxides and other methane forming processes.

The Cetane Number (CN) of methane itself and of natural gas is usually too low for use alone as a fuel in an unmodified diesel engine. Natural gas can be used, for example, in conjunction with a diesel fuel pilot injection that provides sufficient temperature for natural gas combustion. Natural gas can be used alone in a diesel engine that has been modified so a spark plug ignites the natural gas in the cylinder(s). Other engine modifications can, for example, include changing the compression ratio to optimise performance when running on natural gas.

Engines running on natural gas can operate under at least one of two modes; stoichiometrically with oxygen in chemical balance with the amount of natural gas burnt, and typically this corresponds to an air/fuel ratio of almost 17, much higher than for liquid hydrocarbons. The exhaust gas emissions can then be controlled with a “three-way catalyst” similar to those used on conventional gasoline engines. The second operating mode is where oxygen is in excess over the amount of natural gas burnt. Such lean-burn operation has performance benefits, and is commonly used in diesel engines modified to run on natural gas.

A conventional emission control system for a lean-burn natural gas-fuelled diesel engine has an oxidation catalyst, with or without additional components such as particulate traps, eg in the form of a catalysed soot filter, and SCR catalysts together with reductant injector systems. The oxidation catalyst is located in the exhaust system where there is space. All modern heavy-duty diesel engines are turbocharged, and the turbocharger is positioned close to the engine exhaust manifold, not least because the turbocharger unit has to be powered by the exhaust while simultaneously compressing the inlet air.

In the case of natural gas fuelled engines, we believe that a new arrangement would be beneficial. Methane requires a high temperature compared to other higher hydrocarbons, for catalytic oxidation that depends on specific conditions such as the amount of methane present, flow rate etc. The temperature is typically about 450° C. or more. Although a heavy-duty diesel engine operating under load generates exhaust gas temperatures of around 600° C., under part load conditions it is considerably less than this, and the turbocharger is generally of large size and while extracting energy to power the compressor manages to dramatically cool the exhaust gas. Thus, a turbocharger installation generally causes a drop in exhaust gas temperature of 100° C. or more depending on operation conditions. With the oxidation catalyst usually located a metre or more distant from the turbocharger, there is further cooling of the exhaust gas in the exhaust pipe, and the result is that there is frequently only low conversion of the methane over the oxidation catalyst.

At the present time, methane emissions are not regulated in the USA, for historical reasons based on the original intention of the emission regulations being to reduce ozone formation. Therefore, there has been no requirement for reducing methane emissions from an engine or for improving the catalytic conversion of methane. Nonetheless, methane is a significant “greenhouse gas” and it is desirable to minimise methane emissions.

US 2005/0229900 discloses an exhaust system for an internal combustion engine, e.g. a diesel, gasoline or natural gas engine and methods of generating ammonia in situ for reducing certain emission components of the exhaust. The ammonia is generated catalytically from rich exhaust gas produced from a first cylinder group. An oxidation catalyst may be located upstream of a turbocharger for oxidising NO to NO₂ in lean exhaust gas to generate a NO:NO₂ mixture of about 1:1 from a second cylinder group.

CA 2285780 discloses a power generation process and system for generating energy from natural gas, i.e. stationary source power generation. The system includes a catalytic converter located between the engine and a turbocharger. JP 11-350942 discloses a similar system.

SAE 2001-01-0189 discloses a pre-turbo oxidation catalyst for treating hydrocarbon and carbon monoxide from a vehicular diesel engine.

The present invention is intended to improve the control of emissions from lean-burn natural gas-fuelled diesel engines, with an overall improvement in the environment.

According to one aspect, the present invention provides a lean-burn natural gas-fuelled diesel engine, optionally a heavy-duty engine, comprising an exhaust system comprising an oxidation catalyst. The engine may be for use in treating exhaust gas from mobile, e.g. vehicular, applications such as heavy-duty diesel engines for trucks, buses and the like, or for use in treating stationary engines for power generation.

In a particular embodiment, the exhaust system comprises an exhaust-driven turbocharger, wherein the oxidation catalyst is located between the engine and the turbocharger. In one embodiment, there is an oxidation catalyst located within the exhaust manifold for each cylinder. In another embodiment, there is an oxidation catalyst located immediately in front of the turbocharger, for example located within the inlet side of the turbocharger housing.

In embodiments, the oxidation catalyst comprises at least one precious metal, i.e. gold, silver and metals of the platinum group: ruthenium, rhodium, palladium, osmium, iridium and platinum. For example, the at least one precious metal can be selected from the group consisting of platinum, palladium and gold, including combinations thereof. In a preferred embodiment, the precious metal in the oxidation catalyst consists of a combination, optionally as an alloy, of palladium and gold.

In certain embodiments, the oxidation catalyst comprises a combination of palladium and gold, at least some of which may be present as an alloy. This embodiment is particularly advantageous for a number of reasons. Firstly, it can be seen from the Examples that Pd:Au is more active than a comparable Pd-only catalyst for treating methane. Secondly, the activity of palladium-only catalysts can become poisoned by sulphur present in the fuel. However, as set out in the Examples, Pd:Au catalysts are more readily desulphated than Pd-only catalysts. Moreover, in embodiment wherein the Pd:Au catalyst is located pre-turbo, the catalyst can be exposed to higher exhaust gas temperatures which can reduce the possibility of the catalyst becoming sulphated in the first place and/or exposes the catalyst to exhaust gas temperatures that can drive off any sulphur that becomes adsorbed on the catalyst during driving conditions that generate cooler exhaust gases. Pd:Au catalysts also have relatively high thermal durability.

According to another aspect, the invention provides a vehicle, optionally a heavy-duty vehicle, comprising an engine according to the invention.

In another aspect, the invention provides a method of improving the methane emissions from a lean-burn natural gas-fuelled diesel engine, comprising passing exhaust gas from the engine through an oxidation catalyst effective to oxidise methane at the exhaust gas temperature.

In a particular embodiment, the method provides the step of passing exhaust gas treated by the oxidation catalyst into a turbocharger.

Although pre-turbo embodiments of the present invention require improved “packaging” of the system components, the problem is ameliorated because the volume of the oxidation catalyst upstream of the turbocharger can be significantly reduced compared to a conventional large volume oxidation catalyst located downstream of the turbocharger. It is contemplated that an upstream oxidation catalyst may be combined with a downstream oxidation catalyst. In the present invention, the oxidation catalyst is exposed to surprisingly high exhaust gas temperatures, as well as to pulsating exhaust gas pressures, and can show high conversion efficiencies for methane.

It is contemplated that although there will be some small loss of pressure in the exhaust gas upon passing through the oxidation catalyst(s), the exotherm resulting from hydrocarbon oxidation will at least partially compensate by increasing the exhaust gas temperature and the energy content of the exhaust gas entering the turbocharger.

Depending upon the characteristics of the particular engine, and on the emission regulations in force, the emission control system may include additional components. In particular, we wish to mention particulate filters and catalysed particulate filters (with passive or active regeneration control systems), NOx-traps or NOx conversion catalysts, and selective catalytic reduction (SCR) conversion catalysts together with reductant injection means. Additional components such as ammonia destruction catalysts may be located downstream of an SCR catalyst. Electronic control of reductant injection is recommended.

Suitable oxidation catalysts for use in the present invention are loaded (from 10 to 250 g/cu ft) with platinum or palladium or gold, or mixtures thereof together with refractory oxides carried on flow-through substrates. The substrates are preferably metallic, but suitable refractory ceramic substrates may also be considered. Conventional catalyst deposition methods and catalyst structures may be used.

In order that the invention may be more readily understood, the following Examples are provided by way of illustration only and with reference to the accompanying drawings, in which:

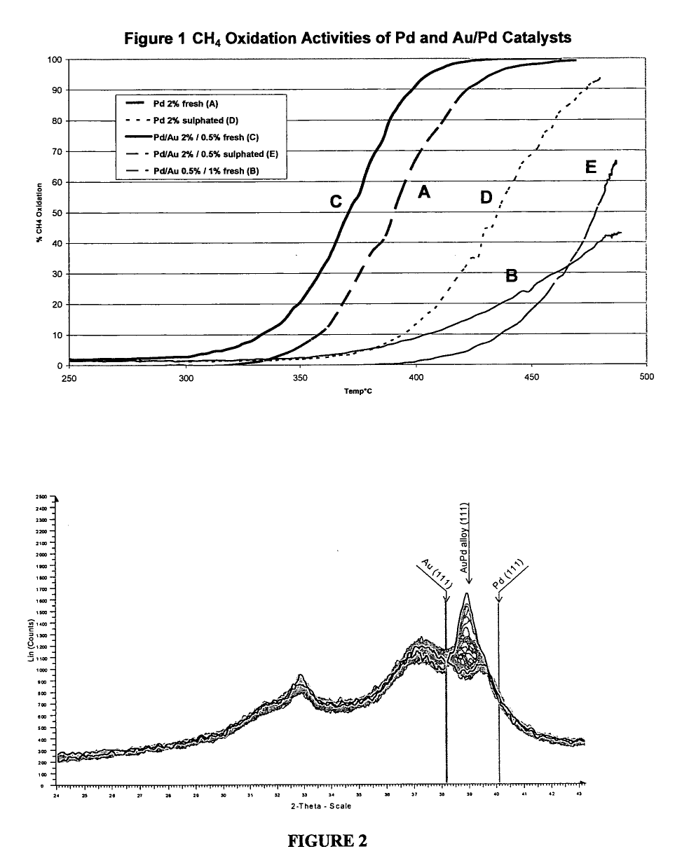

FIG. 1 is a graph showing methane oxidation activities for a range of palladium, gold and palladium/gold catalysts both before and after sulphation; and

FIG. 2 is a graph showing XRD of AuPd catalyst during heating from 30° C. to 850° C.

### EXAMPLES

### Catalyst Preparation and Test Procedure

A series of Pd—Au catalysts dispersed on Al₂O₃ at an atomic composition of Pd:Au between 0:1 to 1:0 were prepared as follows: to an aqueous mixture of palladium nitrate and HAuCl₄ containing particulate alumina support was added a base to hydrolyse and deposit the gold as Au₀ onto the support. The slurry was filtered after an appropriate period, the filtrate was washed to remove chloride ions and the material dried then calcined. The catalysts prepared according to this technique are referred to herein as “fresh” catalysts.

Catalysts were tested in a microreactor having a vertical 10 mm diameter stainless steel reaction tube with catalyst powder (0.4 g) retained on a stainless steel frit. Gas flow (2 litre/minute) was downwards and inlet and exit gas composition was determined with a variety of automated analytical equipment, from which conversions were calculated in the normal way. The catalyst bed temperature was thermostatically maintained at set temperatures by an oven surrounding the reactor tube, or ramped from 110° C. to a predetermined test temperature at a rate of 10° C./minute. Catalysts were sulphated by passing a gas mixture containing nitrogen, water vapour and 100-150 ppm sulphur dioxide (SO₂) at 300° C. for a period such as to expose the catalyst to a predetermined amount of sulphur in the range 15-400 mg sulphur/g of catalyst. The sulphated catalyst was then tested for oxidation activity at temperatures from 110° C. to 500° C. When 500° C. was reached the catalyst was maintained at this temperature for 20 minutes to simulate operation when some sulphur might be released from the catalyst. It was then cooled to 110° C. and the activity test procedure was repeated.

### Example 1

FIG. 1 shows methane oxidation activities for a range of palladium, gold and palladium/gold catalysts before and after sulphation. The test gas comprised carbon monoxide (1000 ppm), nitric oxide (200 ppm), sulphur dioxide (2 ppm), methane (900 ppm), carbon dioxide (4.5%), water vapour (4.5%), oxygen (8%) with the balance nitrogen. These results confirmed palladium catalyst has good activity for methane oxidation (curve A, 2% Pd). In contrast a gold only-containing catalyst had poor methane oxidation activity (curve B, 0.5% Au). Surprisingly, addition of gold to the palladium catalyst significantly enhanced methane oxidation performance (curve C, 2% Pd+0.5% Au).

On sulphation the palladium catalyst showed considerable loss of activity (curve D, 2% Pd), and the catalyst containing palladium and gold showed greater loss of activity (curve E, 2% Pd+0.5% Au). Thus the unsulphated palladium/gold catalyst has excellent activity, and poor performance when sulphated. A catalyst containing a relatively high amount of gold (B, 0.5% Pd and 1% Au) had such poor activity fresh it was not tested when sulphated.

### Example 2

This example shows palladium/gold catalyst is desulphated and reactivated for oxidation reactions at much lower temperatures than palladium-only catalyst, and that this takes place at lower temperatures than those present before the turbocharger on a natural gas fuelled engine, such that desulphation takes place there effectively continuously so maintaining high catalytic performance. The catalysts were prepared and tested as described above. The test gas comprised carbon monoxide (1000 ppm), nitric oxide (200 ppm), sulphur dioxide (2 ppm), propene, (900 ppm as C₁), carbon dioxide (4.5%), water vapour (4.5%), oxygen (12%) with the balance nitrogen. The test results obtained are given in Table 1 in the form of temperature needed to achieve 80% carbon monoxide conversion (CO_{T80}) and 50% hydrocarbon conversion (HC_{T50}).

TABLE 1
Test results for unsulphated, sulphated, and sulphated catalyst
after treatment at 500° C. for 20 minutes. Catalysts
were aged at 750° C. for 48 hours before testing.

| | | | After exposure | | | |
|---|---|---|---|---|---|---|
| | Results for | | to 45 mg | | After reactivation | |
| | fresh catalyst | | S/g catalyst. | | 500° C./20 min | |
| Catalyst/wt % | CO_{T80} | HC_{T50} | CO_{T80} | HC_{T50} | CO_{T80} | HC_{T50} |
| Au 1% | 325 | 317 | | | | |
| Au/Pd 0.25/2% | 160 | 168 | 262 | 231 | 230 | 219 |
| Au/Pd 0.6/ | 159 | 159 | 251 | 224 | 194 | 193 |
| 1.25% | | | | | | |
| Au/Pd 0.8/ | 166 | 161 | 258 | 227 | 185 | 184 |
| 0.8% | | | | | | |
| Au/Pd 1/0.5% | 162 | 156 | 263 | 229 | 182 | 178 |
| Pd 2.5% | 175 | 185 | 272 | 242 | 245 | 233 |

These results show addition of gold to palladium catalyst lowers the temperature at which sulphated catalyst is reactivated for oxidation reactions, and that this effect can be substantial. These catalysts were aged by heating at 750° C. for 48 hours before testing, and we believe the enhanced reactivation of the palladium/gold formulations is caused, at least in part, by the gold and palladium forming an alloy. X-ray diffraction confirmed alloy formation. Gold and palladium have almost perfect mutual solubility with the corresponding lattice expansion correlating linearly with the composition of the alloy formed.

FIG. 2 shows the X-ray reflections in the 20 region from gold (III) and palladium (III). As the catalyst sample was heated from 30° C. to 850° C. the alloy phase reflection between these two marked reflections in FIG. 2 grew in intensity confirming the presence of this phase.

1. A lean-burn natural gas-fuelled diesel engine comprising an exhaust system comprising an oxidation catalyst.

2. An engine according to claim 1, wherein the exhaust system comprises an exhaust-driven turbocharger and wherein the oxidation catalyst is located between the engine and the turbocharger.

3. An engine according to claim 2, wherein the oxidation catalyst is located within an exhaust manifold.

4. An engine according to claim 3, wherein the engine has a plurality of cylinders and each cylinder has an oxidation catalyst within its exhaust manifold.

5. An engine according to claim 2, wherein the oxidation catalyst is located within the exhaust gas inlet of the turbocharger.

6. An engine according to claim 1, wherein the oxidation catalyst comprises at least one precious metal.

7. An engine according to claim 6, wherein the at least one precious metal is selected from the group consisting of platinum, palladium gold and combinations thereof.

8. An engine according to claim 7, wherein the oxidation catalyst comprises a combination of palladium and gold.

9. An engine according to claim 8, wherein at least some of the palladium and gold is present as an alloy.

10. A vehicle comprising an engine according to claim 1.

11. A stationary engine for power generation according to claim 1.

12. A method of improving methane emissions from a lean burn natural gas-fuelled diesel engine, comprising passing exhaust gas from the engine through an oxidation catalyst effective to oxidise methane at the exhaust gas temperature.

13. A method according to claim 12, comprising passing the exhaust gas treated by the oxidation catalyst into a turbocharger.

14. A vehicle according to claim 10, wherein the vehicle is a heavy-duty vehicle.

15. A system comprising:
a lean burn natural gas-fuelled diesel engine; and
an exhaust system,
wherein the exhaust system comprises an oxidation catalyst and a turbocharger, and the oxidation catalyst is positioned upstream of the turbocharger.

16. A system according to claim 15, wherein the exhaust system comprises a second oxidation catalyst positioned downstream of the turbocharger.

17. A system according to claim 15, wherein the exhaust system further comprises an additional component selected from the group consisting of a particulate filter, a NOx trap, a selective catalytic reduction conversion catalyst, an ammonia destruction catalyst, and combinations thereof.
